(19) United States
(12) Patent Application Publication
(10) Pub. No.: US 2010/0073481 A1
(43) Pub. Date: Mar. 25, 2010

(54) CEILING AND WALL SURFACE MOUNTED DATA MANAGEMENT, REMOTE MONITORING AND INFORMATION DISPLAY SYSTEM

(76) Inventors: Christopher Kaltenbach, Tokyo (JP); Luke Nihlen, Albuquerque, NM (US); Luis M. Ortiz, Albuquerque, NM (US)

Correspondence Address: ORTIZ & LOPEZ, PLLC, P.O. BOX 4484, ALBUQUERQUE, NM, 87196-4484, US

(21) Appl. No.: 12/246,891

(22) Filed: Oct. 7, 2008

Related U.S. Application Data
(60) Provisional application No. 61/098,522, filed on Sep. 19, 2008.

(51) Int. Cl. H04N 7/18; B60Q 1/124; G08B 13/14; G06Q 10/00

(52) U.S. Cl. 348/151; 362/233; 340/572.1; 705/28

(57) ABSTRACT

A multimedia system for deployment along ceilings and/or walls within a monitored environment (store, warehouse, manufacturing, government operations) that can provide two-way visual information, enable two-way wireless data communication between floor-based equipment/personnel/products and local and/or remote servers. A surface-mounted system can reduce or eliminating the need for physical cabling and can enable product/person RFID tracking capabilities within a monitored environment. Feature consolidation reduces energy consumption requirements and expense of deployment. The multimedia system can be universally used in retail, transportation hub, manufacturing environments and government environments and for varied applications given its capability to enable bidirectional communications and data management for real time assessment and archival purposes.

### CONTINUATION AND INVENTION PRIORITY

The present invention is a continuation and claims the benefit of U.S. Provisional Application Ser. No. 61/098,522 entitled “CEILING AND WALL SURFACE MOUNTED DATA MANAGEMENT, REMOTE MONITORING AND INFORMATION DISPLAY SYSTEM,” which was filed on Sep. 19, 2008.

### FIELD OF THE INVENTION

The present invention is generally related to data management and information display systems. More particularly, the present invention is related to digital signage in the form of a rotating display that is circular in shape, uses less energy via its use of LEDs and incorporates the persistence of vision phenomena (e.g., flicker fusion rate/threshold) to convey information. The present invention is also related to a wireless data management and retrieval hardware and software that can be integrated within a rotating LED display adapted to acquire information from a deployed environment (e.g., sales floor, manufacturing floor, enclosed, government controlled operational areas). Information managed by the system includes: acquiring buyer impressions, provide venue security, enabling two-way data communications between the system and disparate devices located beneath and around the system (e.g., on the floor) such as equipment, handheld mobile devices, points of sale, and RFID capabilities for tracking (e.g. locating and identifying) equipment, goods and personnel.

### BACKGROUND OF THE INVENTION

Digital retailing technologies are creating new in-store display options. In the retail world, “POP” is used to refer to point-of-purchase advertising displays. POP displays can take various forms, including shelf-mounted signs, hanging posters, and more. Since an estimated 70% of purchase decisions are made within the retail store itself, effective POP displays can have a dramatic impact on sales for a particular product category or brand. Recently, static signs have begun to give way to electronic, dynamically updated point-of-purchase displays that present targeted product information, instant coupons, and more. The software used to control these dynamic POP displays typically allows for near-real time content updates, allowing brand managers to run instant marketing experiments, geographically targeted promotions campaigns, and more.

One problem with displays used in today's retail environments is the cost associated with implementing such systems. Large flat panel, liquid crystal display (LCD) or plasma screens are expensive to purchase and install throughout large establishments and also consume much energy during sustained operation. Given the rising costs of energy and the pressure and appeal for commercial entities to conserve energy and become “green” in their approach of running business, less expensive display systems are still needed. It has also become more desirable to save costs during new equipment implementations at commercial enterprises and government operations. It is desirable to procure, install and utilize equipment that might provide multiple features and options to the entity when used.

Realizing the increasing demands and costs for energy and the need for equipment feature consolidation and new equipment budget reductions that face private and public entities, large and small, the present inventors conceived of a system, apparatus and methods entities will be able to less expensively deploy while also conserving energy, communicate and manage the collection of information, and consolidate data management features not previously considered for combination as taught herein.

### SUMMARY OF THE INVENTION

In accordance with features of the present invention, digital signage in the form of a rotating display is circular in shape uses less energy via the incorporation of light emitting diodes (LEDs) within its surface that is facing observers and the incorporation of the persistence of vision phenomena (e.g., flicker fusion rate/threshold) to convey information to the observers.

In accordance with another features of the present invention an information retrieval module can be integrated within the center of a rotating LED display and can thereby be adapted to acquire (e.g., transmit and/or record) buyer impressions and provide venue monitoring and security.

The present invention can support omni-direction communication between the rotating display and venue patrons and workers. Wireless data communications can be provided as part of the present invention. In accordance with features of the present invention, digital signage in the form of a rotating display that is circular in shape, uses less energy via its use of LEDs and incorporates the persistence of vision phenomena (e.g., flicker fusion rate/threshold) to convey information.

The present invention is also related to a information management and retrieval hardware and/or modules integrated within a rotating LED display adapted to acquire information from a deployed environment (e.g., sales floor, manufacturing floor, enclosed operational area). Information managed by the system includes: acquiring buyer impressions, provide venue security, enabling two-way data communications between the system and disparate devices located beneath and around the system (e.g., on the floor) such as equipment, handheld mobile devices, points of sale and RFID capabilities communicating with and tracking the status of equipment, goods and personnel.

In accordance with yet another feature of the present invention, the rotating LED display can be mounted to ceiling and walls within a shopping venue, manufacturing facility or government facility. Several rotating LED displays can be networked within a facility to support communications between each other and disparate devices located within the facility.

In accordance with yet another feature of the present invention, the rotating LED display can be mounted to ceiling and walls within a shopping venue, manufacturing facility or government facility. The networking of several rotating LED displays can enable location tracking of disparate devices located within the facility networked within a facility via triangulation of signals based on return signals received by the networked rotated displays from devices located within the facility.

In accordance with yet another feature of the present invention, the rotating LED display can be mounted to ceiling and walls within a manufacturing operation. A facility's interior ceiling space can be used for displaying image/text/moving images from the rotating LED display in parallel with the surface of the ceiling.

In accordance with yet another feature of the present invention, the rotating LED display can be mounted to ceiling and walls within a government facility. A facility's interior ceiling space can be used for displaying images/text in parallel with the surface of the ceiling.

In accordance with other features of the present invention, an advertising (Point-of-Purchase) display and monitoring method/system can be incorporated into a single system that provides real-time control and feedback (remotely managed) in relation to an observed correlations between impressions and consumer actions (i.e., similar to Point-of-Purchase Display system but operable for data collection throughout sales floor space).

In accordance with another feature of the present invention, an advertising (Point-of-Purchase) display and monitoring method/system can be incorporated into a single system that provides real-time control and feedback (remotely managed) in relation to an observed correlations between impressions and consumer actions (i.e., similar to Point-of-Purchase Display system but operable for data collection throughout sales floor space).

A server can be provided, local or remote, to provide data to and retrieve data from the display and monitoring system. Although the server's location is not restricted, remote backup of data can be provided where local server deployment is provided. Remote monitoring of sensitive environment, such as U.S.-based corporation operating in foreign facilities, remote emergency operations facilities from a centralized Emergency Management Operation Center (EMOC), remote military facilities monitored from stateside command and control operations.

### BRIEF DESCRIPTION OF THE DRAWINGS

FIG. 1 illustrates a surface-mounted display system mounted from the ceiling of a publicly accessible environment;

FIG. 2 illustrates side and bottom perspectives of a surface-mounted display system and associated components.

FIG. 3 illustrates components that can be located within a surface mounted display system including data network access and access to remote resources (e.g., servers, databases).

FIG. 4 illustrates a system architecture for system incorporation surface-mounted display systems for conveying information to observers and monitoring observer behavior in real time through transmitting video information from discrete video camera located on the display.

FIG. 5 illustrates a components enabling the flow for/in the solicitation of both location ceiling space and advertising message/camera data with LED/Camera Owner, Advertising Agency and Commodity Company.

FIG. 6 illustrates a manufacturing environment whereby the display and camera, along with wireless bi-directional communication can monitor and instruct supply chain/equipment/employees.

FIG. 7 illustrates an environment whereby the display and camera, along with wireless bidirectional communication can monitor and instruct personnel located within a controlled environment.

### DESCRIPTION OF EMBODIMENTS

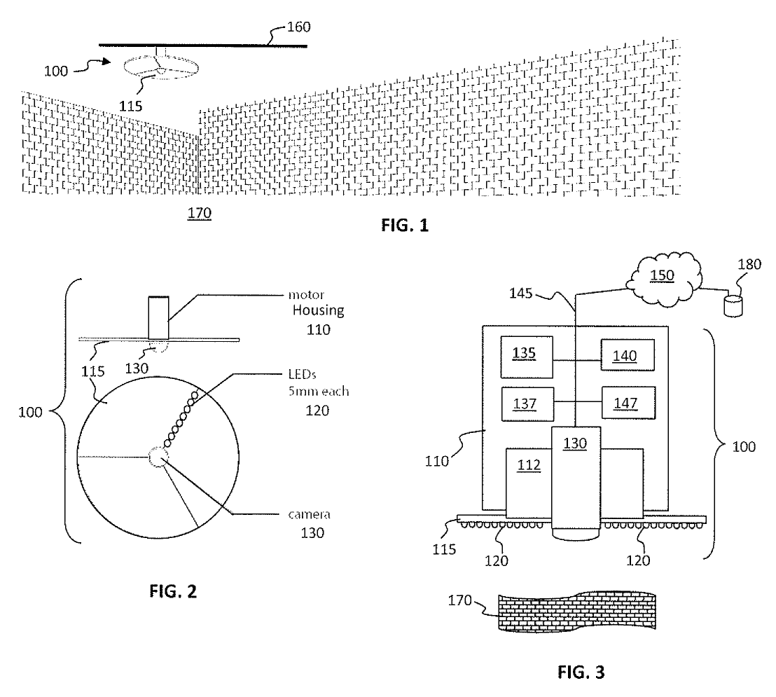

Referring to FIG. 1 and 2, a surface-mounted display system 100 is shown mounted to the ceiling 160 within a publicly accessible space 170 (e.g., a sales area of a retail store, a transportation hub (e.g. airport, bus depot, train station, taxi depot), a manufacturing facility, a government facility). The surface-mounted display system 100 includes a thin disc 115 (which can be provided at any diameter) mounted so that its radial axis is parallel to the axis of the ceiling (or to a wall if vertically oriented installation is provided), a motor 110 mounted centrally in the rotational axis of the disc 115 for spinning the disc 115, and an array of light emitting diodes (LEDs) 120 in red, Green, and Blue embedded in the disc 115 that coordinate their lighting action based on the rotation angle of the disc 115 to display an image.

According to another feature of the present invention, a video camera 130 can be mounted centrally and below the rotating disc 115 on the surface-mounted display system 100. Video camera capability can be provided for monitoring consumer activity below the disc.

Referring to FIG. 3, according to another feature of the present invention, a data network connection 150 (wired and/or wireless) can be provided to the ceiling-mounted display system 100 in order to deliver data from remote resources (e.g., remote or local network servers and /or databases) to the surface-mounted display system 100. The data network connection can be provided via cable 145 together with power (provided through wiring means known in the electrical and data installation fields). If wireless communications is provided to the surface-mounted display system 100, wireless capabilities 140 within the surface-mounted display system 100 can also provide wireless data connections to desperate devices located within the store to enable wireless communications (e.g., 802.11 and WIMAX hot spot capabilities, or via cellular data communications means such as CDMA, Edge, GSM, HSDPA, 3G/4G networks, etc.).

Wireless communications within/from the surface-mounted display system 100 can support data transactions and communications between the surface-mounted display system 100 and handheld devices (e.g., PDAs, Smart phones, cell phones, WiFi-enabled portable devices, laptop computers, portable tools) as well as stationary devices (e.g., stationary tools, and desktop computers) used in the environment 170. Data transactions can include retrieval of coupons, retrieval of product specifications and/or additional product background information (e.g., consumer reports, competitive price data from competitor venues) from remote resources 180. The Wireless capabilities can also be provided in the form of an RFID detection and tracking module 147. RFID tracking can enable product monitoring (e.g., product movement, product stock replenishment requirements) and also movement of store personnel bearing RFIDs. A memory 135 can be provided for the storage of media including images/text/moving images to display on the spinning disc 115 and for storing video recordings of consumer activity collected by the video camera 130. A microprocessor 137 can be included for controlling lighting of the LEDs 120, driving the wireless Internet adapter 140 and enabling the communication of and collection of data (e.g., video from the video cameras, communications with mobile and fixed devices in the environment using RFID-enable hardware and wireless data network hardware).

The thin disc 115 can be made of any lightweight, durable material (e.g. plastic, carbon fiber aluminum)), this disc will allow for the mounting of multiple arrays of LEDs 120 from its center radiating to the edge of its outer circumference with little to no deflection. The motor 112 should be able to provide the necessary speed and torque to spin the disc at a rate fast enough to create the persistence of vision phenomena (flicker fusion rate/threshold).

The network connection can include a data network communications adapter 140 mounted within an housing associated with and above the disc providing data network, e.g., Internet, connectivity to consumers below the disc 115 as well as connectivity for the display system 100 itself. The data network communications adapter 140 can be wireless or wired. Wireless adapters can include the 802.11 family of wireless routers as well as the newest class of hardware supporting WiMAX. A wired Ethernet adapter provides wired data communication as an optional source for reliable, secure data network connectivity. Both wired and wireless adapters supporting data communications for the data network communications adapter can be included within the “network module” for definitional purposes. Wireless communication would allow for more flexibility in physically locating the surface-mounted display systems 100 within a venue (monitored environment).

A discreet video camera 130 can be mounted centrally below the rotating disc 115 for monitoring consumer traffic/behavior below the disc. Integration of digital signage with in-store databases 180 can be provided with the system to enhance relevancy of image/text/moving image content.

A software management system can be provided within a remote server 180 to provide an end to end architecture, client device management system for more than one ceiling mounted display. The software is simple and intuitive to user and ideally includes use of a web interface and network connection, allowing for complete remote administration and diagnostics.

The surface-mounted display 100 when used as a marketing system can include the use of persistence of vision phenomena, which incorporate a flicker fusion rate/threshold). Furthermore, bright lights against a dim background when viewed take at least a second to fade from human vision even if the light has moved or has been turned off.

With the current system the position of the array of LEDs 120 on the disc 115 with the image that is attempting to be displayed are used to determine the appropriate pixels to light as the array of LEDs 120 move through space. Such visual data deliver can also be effective in non-sales and marketing environments such as manufacturing floors where status and safety information must be provided to employees (especially in noisy environments).

The surface-mounted display system 100 of the present invention can be used in sales as well as manufacturing environments and government operations. In sales environments, consumers can be provided with special sale information, new product release information, and buyer behavior can be monitored. In a large non-public environment, the surface-mounted display system 100 can provide management with floor monitoring capabilities, supply chain management capabilities (e.g., using RFID), and wireless bidirectional communication with, for example, manufacturing equipment and computers used throughout a manufacturing floor, which can thereby reduce the need for cabling, especially where the environment is temporary (e.g., military command and control facilities, FEMA shelters).

Display devices can be in communication over the Internet with a central, remote server 180 . Each display device 180 can report demographic data as transmitted by associated cameras 130 to a central server 180 via the wireless or wired Internet connection 150. In a sales environment, the central server software (which can include advertising agencies, commodities companies, owners of interior space) can then determine the appropriate advertising (image and/or text and/or moving image) information for display on individual display devices 100 and can send updated images and/or text and/or moving image information to the individual display devices for display (initial storage in the memory and/or instantaneous or eventual display).

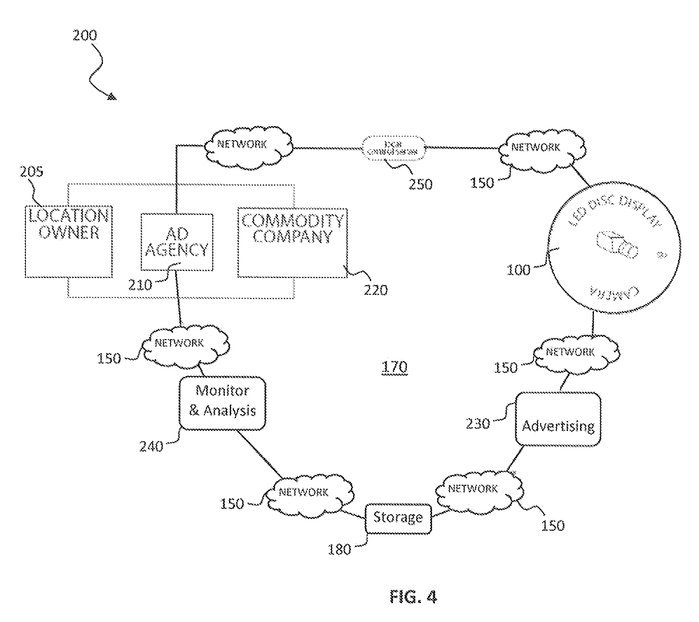

Referring to FIG. 4, in this diagram of a system deployment 200 capable of providing information to observers (consumers) and for monitoring consumer (observer) behavior in real time. Consumer/observer behavior can be monitored through video images obtained (captured) by discrete video cameras 130 located on the surface-mounted display system 100, processed and then transmitted as video data from the surface-mounted display system 100 to remote a server 180 for remote observation and analysis. With the system, a store owner 205, advertising agency 210 and/or Products Company 220 can interact and be authorized to view and respond to customer behavior and then respond to a costumer behavior through the changing/uploading/refreshing of image/text/moving images as messages 230 (accessed/provided remotely) for display at the surface-mounted display system 100. Acquired data can be archived in local memory 135 or remote data storage 180. A local control server 250 can enable all operations associated with a distributed system and network of surface-mounted display devices 100 throughout a venue 170. All operational and data management communications can provided over a data network 150 (with the exception of RFID tag data retrieval via challenge and response signals). When set up in a network configuration within a single environment, a plurality of surface-mounted display devices can operate together to receive RFID signals from RFID tags located within a large facility to triangulate the location of RFID tags (and associated equipment) based on return signals from tracked RFID tags. The network can also ensure seamless communications between a moving tool or system within the facility and the communications network. Operating as a network of wireless routers, surface-mounted display systems can also support in-building mobility communications for cellular based wireless communications devices, again ensuring seamless communications for a roving handheld communicator.

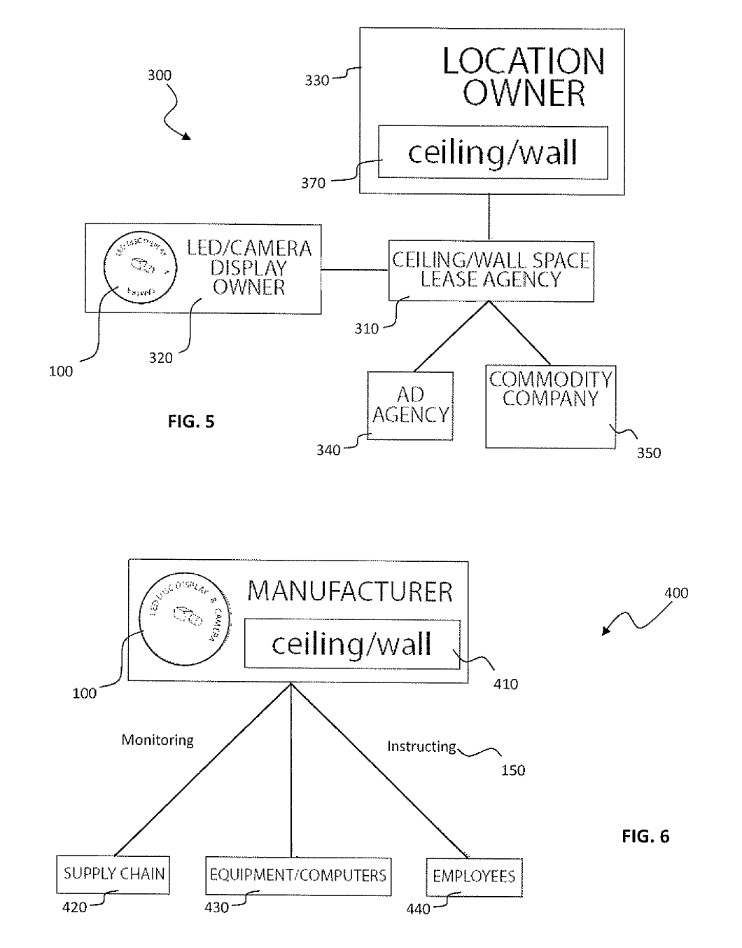

Referring to FIG. 5, a system diagram 300 is illustrated for modules that cooperate together in a commercial environment to enable contractual data management flow associated with the solicitation of ceiling/wall space 370 and the capture and utilization of advertising message/camera data managed by a surface-mounted display device 100. Such a scenario identifies ceilings/wall space 370 as separate real estate leased within existing retail, hospitality, transportation and commercial enterprises 330. This business model establishes the need for a Ceiling Space Leasing Agent 310 to establish/manage agreements between LED Display/Camera Owner 320 and Location Ceiling Space Owners 330. It provides both the LED Display/Camera Owner 320 and Location Ceiling Space Owner 330 a third party representative to integrate with Advertising Agencies 340 and Commodity Companies 350 for the leasing of advertisement time/space, and the for use of data associated with consumer behavior (e./g., reactions) with respect to product placement and advertisements within the venue.

Referring to FIG. 6 a system diagram 400 is illustrated for a manufacturing environment whereby display devices 100 located on the surface of a manufacturing ceilings/walls 410 and communicating as part of a network over wireless bidirectional communications 150 can monitor manage supply chains 430, operational of equipment 440 and status of employees 450. Such a system provides manufacturing managers with the ability to monitor, analyze and control/direct manufacturing operations. Managers can now provide real-time critical decision making and support to employees, track product through an overall end-to-end supply chain given broader operation visibility, and enables the use of diagnostic tools over manufacturing equipment (e.g., sensor-enabled machines and control computers).

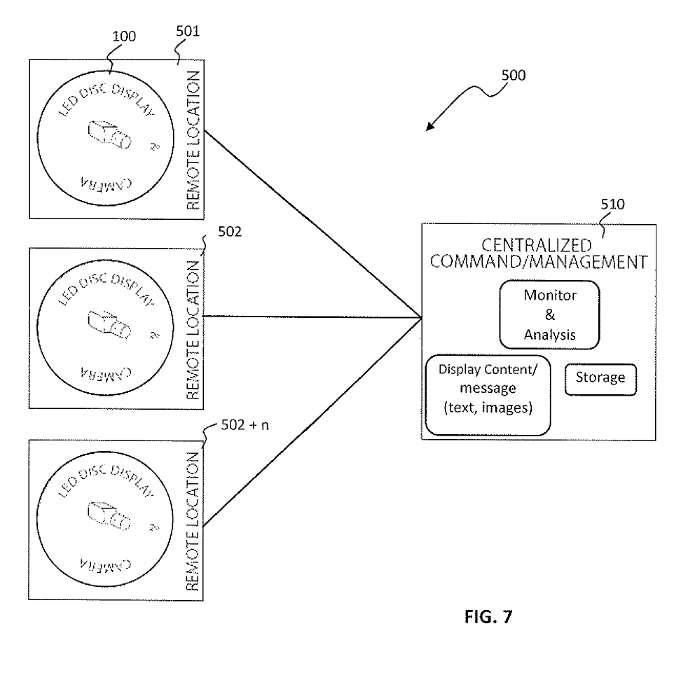

Referring to FIG. 7, a system diagram 500 is illustrated for a distributed environment monitoring system. In the illustrated scenario, distributed (e.g., remote from each other) locations (501) through (502+n) include at least one display system 100 including video camera monitoring 130 and communications capabilities as previously described. The distributed display systems communicate over data communications networks to a centralized command/management center 510. Wireless bidirectional communication can provide information to from surface-mounted display systems 100 from/to command centers 510. Communications can be secure. Use of a network of display systems 100 through a theatre of operations provides enhanced situation analysis to command elements in government. Military and humanitarian relief environments would most benefit from the consolidated monitoring, communications, information transfer and archiving of activities that can be provided by the present system. Even in commercial, manufacturing, and private environments, distributed data management, monitoring and communications provided by the present invention can provide various advantages.

The present invention provides remote and local managers, contractors, commanders with the ability to analyze operations, provide real-time information and decision support to all decisions makers, employees and personnel located within monitored areas, enables the monitoring of equipment/personnel, and enables security/status monitoring/tracking and intelligence/information gathering (government or commercial) needed for situation awareness at remote sites in order to secure or enhance operations, or to increase the ability to generate income (e.g., where advertising is concerned).

1. The surface-mounted display system, comprising:
a thin disc (of any diameter) mounted to a ceiling so that its radial axis is parallel to the axis of a building surface including at least one of a ceiling and wall;
a motor mounted centrally in the rotational axis of the disc for spinning the disc, said motor adapted to provide the necessary speed and torque to spin the disc at a rate fast enough to create the persistence of vision phenomena (flicker fusion rate/threshold).
at least one array of LEDs mounted on the lower surface of the thin disc from the thin disc's center and radiating to the edge of its outer circumference with little to no deflection wherein said thin disc made of any lightweight, strong durable material and adapted to allow for the mounting of multiple LEDS.

2. The surface-mounted display system of claim 1, further comprising Red, Green, and Blue LEDs embedded in the disc that coordinate their lighting action based on the rotation angle of the disc to display an image.

3. The surface-mounted display system of claim 1, further comprising a wireless data communications adapter mounted above the disc providing data network connectivity to consumers below the disc as well as connectivity for the display device itself to enable the provision of, retrieval of and management of data.

4. The surface-mounted display system of claim 1, further comprising a wired Ethernet adapter as an optional source for reliable Internet connectivity.

5. The surface-mounted display system of claim 1, further comprising a discreet video camera mounted centrally below the rotating disc for monitoring consumer traffic/behavior below the disc.

6. The surface-mounted display system of claim 1, further comprising a memory for the storage of the image/text/moving images to display on the spinning disc as well as the recent traffic/behavior data as collected by the camera.

7. The surface-mounted display system of claim 1, further comprising a control computer for lighting the LEDs, driving the wireless Internet adapter and collecting data from the video camera.

8. The surface-mounted display system of claim 1, further comprising integration of digital signage with in-store databases to enhance relevancy of image/text/moving image content.

9. A data management system comprising:
a circular, LED-based surface-mounted display adapted to provide information to people located within a facility when the circular, LED-based surface-mounted display is spinning;
wireless communications hardware supporting bi-direction data communication between the data management system and remote users and further adapted to enable communications access to a remote server;
access to a remote server for retrieving and providing data to/from the data management device; and
a camera capable of recording video within said facility and transmitting recorded video to the remote server.

10. The data management system of claim 9, further comprising an RFID reader capable of reading RFID tags located within the facility.

11. A surface-mounted display system including:
a thin disc (of any diameter) mounted so that its radial axis is parallel to the axis of the ceiling; a motor mounted centrally in the rotational axis of the disc for spinning the disc;
red, Green, and Blue LEDs embedded in the disc that coordinate their lighting action based on the rotation angle of the disc to display an image;
a network connection;
a video camera mounted centrally below the rotating disc for monitoring consumer activity below the disc;
a memory for the storage of media including images/text/moving images to display on the spinning disc and for storing video recordings of consumer activity collected by the video camera; and
a control computer included for lighting the LEDs, driving the wireless Internet adapter and collecting data from the video camera.

12. The surface-mounted display system of claim 11, wherein the thin disc is made of lightweight, durable material, and will allow for the mounting of multiple arrays of LEDs from its center radiating to the edge of its outer circumference with little to no deflection.

13. The surface-mounted display system of claim 11, wherein the motor is adapted to provide the necessary speed and torque to spin the disc at a rate fast enough to create the persistence of vision phenomena.

14. The surface-mounted display system of claim 11, further comprising a data network communications adapter mounted providing data network connectivity to consumers below the disc as well as connectivity for the display device itself.

15. The surface-mounted display system of claim 11, further comprising wherein a discreet video camera mounted centrally below the rotating disc for monitoring consumer traffic/behavior below the disc

16. The surface-mounted display system of claim 11, further comprising wherein integration of digital signage with in-store databases can be provided with the system to enhance relevancy of image/text/moving image content.

17. The surface-mounted display system of claim 11, further comprising wherein a software management system can be provided within a remote server to provide an end to end architecture, client device management system for more than one ceiling mounted display.

18. The surface-mounted display system of claim 11, further comprising wherein the display system can include the use of persistence of vision phenomena, which incorporates the flicker fusion rate/threshold phenomena.

19. The surface-mounted display system of claim 11, further comprising wherein bright lights against a dim background when viewed takes at least a second to fade from human vision even if the light has moved or has been turned off.

20. The surface-mounted display system of claim 11, further comprising wherein display devices are each be in communication over the Internet with a remote server.

21. The surface-mounted display system of claim 11, further comprising wherein each display device can report demographic data as transmitted by associated cameras to a server via the wireless or wired Internet connection.

22. The surface-mounted display system of claim 11, further comprising a server, including software capable of determining the appropriate advertising message for display on display devices and also adapted to send updated images and/or text and/or moving image information to the display device for display.
